(19) United States
(12) Patent Application Publication
(10) Pub. No.: US 2014/0125175 A1
(43) Pub. Date: May 8, 2014

(54) SPINDLE MOTOR AND HARD DISK DRIVE INCLUDING THE SAME

(71) Applicant: SAMSUNG ELECTRO-MECHANICS CO., LTD., Suwon (KR)

(72) Inventors: Shin Young CHEONG, Suwon (KR); Jung Hwan Song, Suwon (KR); Satoru Sodeoka, Suwon (KR)

(73) Assignee: SAMSUNG ELECTRO-MECHANICS CO., LTD., Suwon (KR)

(21) Appl. No.: 13/757,081

(22) Filed: Feb. 1, 2013

(30) Foreign Application Priority Data
Nov. 2, 2012 (KR) 10-2012-0123361

(51) Int. Cl. H02K 7/08

(52) U.S. Cl. CPC H02K 7/08
USPC 310/90

(57) ABSTRACT

There are provided a spindle motor and a hard disk drive including the same, the spindle motor includes: a shaft fixedly installed on a base member and including an upper thrust member provided in an upper portion thereof and protruded outwardly in a radial direction, a sleeve supported by fluid dynamic pressure so as to be rotatable with respect to the shaft, a hub extended from the sleeve outwardly in the radial direction, and a sealing cap mounted on the hub and extended to an upper portion of the upper thrust member so as to cover a space between the upper thrust member and the hub formed in the axial direction.

### CROSS-REFERENCE TO RELATED APPLICATIONS

This application claims the priority of Korean Patent Application No. 10-2012-0123361 filed on Nov. 2, 2012, in the Korean Intellectual Property Office, the disclosure of which is incorporated herein by reference.

### BACKGROUND OF THE INVENTION

1. Field of the Invention

The present invention relates to a spindle motor and a hard disk drive including the same.

2. Description of the Related Art

A hard disk drive (HDD), an information storage device, reads data stored on a recording disk or writes data to a recording disk using a read/write head.

A hard disk drive requires a recording disk driving device capable of driving the recording disk. In the recording disk driving device, a small spindle motor is used.

An upper portion of the spindle motor has a rotor hub, on which the recording disk is mounted, mounted thereon, wherein the rotor hub has a disk shape in which it is extended in a radial direction based on a shaft. Therefore, the recording disk mounted on the rotor hub may be fixed by a clamp provided on an upper surface of the rotor hub in an axial direction.

However, according to the related art, a thickness standard of a hard disk drive (HDD) is 9.5 mm in a hard disk drive for a mobile device and 15 mm in a hard disk drive for a server. Therefore, a spindle motor mounted in the hard disk drive may be somewhat lengthily formed in the axial direction. That is, a bearing span between upper and lower radial bearings may be sufficiently secured.

However, in accordance with recent miniaturization of an electronic device, it has been demanded that hard disk drives used in electronic devices have a miniaturized thickness standard of 5 mm or less. Therefore, spindle motors used in hard disk drives have been formed to have a significantly short length in the axial direction.

In accordance with the trend toward the thinness of the spindle motor as described above, a method of allowing the clamp provided on the upper surface of the rotor hub in the axial direction to not waste a space in the axial direction has been demanded.

In addition, the spindle motor may be divided into a shaft rotating type spindle motor in which a rotor hub is mounted on a shaft, such that the shaft is rotated with the rotor hub, and a fixed shaft type spindle motor in which a shaft is fixedly mounted on a base member and a rotor hub is mounted on a sleeve supported so as to be rotatable with respect to the shaft, such that the sleeve is rotated.

Here, in the case of a thin fixed shaft type spindle motor, a top cover may be fixedly mounted to an upper end of the shaft. The top cover may be provided along a part of which an upper surface in the axial direction is higher in the shaft and an upper thrust member disposed outwardly of the shaft in the radial direction.

In this case, a distance between facing surfaces of the top cover and the hub in the axial direction may be narrowed, as compared with the motor according to the related art. However, since the top cover may be warped by external force, contact between the top cover and the hub should be prevented.

The following Related Art Document has disclosed a clamping member 50 provided on a hub.

### RELATED ART DOCUMENT

(Patent Document 1) Korean Patent Laid-Open Publication No. 2007-0029457

### SUMMARY OF THE INVENTION

An aspect of the present invention provides a spindle motor capable of allowing a clamp fixing a recording disk to not occupy a space in an axial direction.

An aspect of the present invention also provides a spindle motor having a structure in which a contact between a top cover and a hub is not generated in spite of using a thin fixed shaft type spindle motor.

An aspect of the present invention also provides a spindle motor having a structure in which a gap between a top cover and a hub is used to improve performance of the spindle motor as the gap between the top cover and the hub is narrowed.

According to an aspect of the present invention, there is provided a spindle motor including: a shaft fixedly installed on a base member and including an upper thrust member provided in an upper portion thereof and protruded outwardly in a radial direction; a sleeve supported by fluid dynamic pressure so as to be rotatable with respect to the shaft; a hub extended from the sleeve outwardly in the radial direction; and a sealing cap mounted on the hub and extended to an upper portion of the upper thrust member so as to cover a space between the upper thrust member and the hub formed in the axial direction, wherein the upper thrust member and the sleeve or the hub include a liquid-vapor interface formed therebetween, and a first gap between facing surfaces of the upper thrust member and the sealing cap in the axial direction, a second gap between facing surfaces of the sealing cap and the shaft or the upper thrust member in the radial direction, and a third gap, an axial distance between an upper surface of the sealing cap in the axial direction and a line radially extended from a top of one of the shaft and the upper thrust member, one of which having an upper surface positioned to be higher than that of the other in the axial direction, are narrow enough to form a labyrinth seal, and the first to third gaps have sequentially alternated relative sizes.

The first and third gaps may be larger than the second gap.

An upper surface of the hub may be provided with a first seating part stepped downwardly in the axial direction so that the sealing cap is seated on an inner side thereof in the radial direction and a facing part disposed outwardly of the first seating part in the radial direction, and a fourth gap, an axial distance between the facing part and the line radially extended from the top of one of the shaft and the upper thrust member, one of which having an upper surface positioned to be higher than that of the other in the axial direction may be narrow enough to form the labyrinth seal.

The first to fourth gaps may have sequentially alternated relative sizes.

The facing part may be a first facing part positioned in a position higher than an upper surface of the sealing cap in the axial direction, and the first and third gaps may be larger than the second gap and the fourth gap may be smaller than the third gap.

The facing part may be a second facing part positioned in a position lower than an upper surface of the sealing cap in the axial direction, and the first and third gaps may be smaller that the second gap and the fourth gap may be larger than the third gap.

The sealing cap may be inclined upwardly from an outer portion thereof toward an inner portion thereof in the radial direction.

The sealing cap may be inclined upwardly from an outer portion thereof toward an inner portion thereof in the radial direction.

The sealing cap may include an upward protrusion part formed at an outer edge thereof in the radial direction and protruded upwardly in the axial direction, and a fifth gap, an axial distance between the upward protrusion part and the line radially extended from the top of one of the shaft and the upper thrust member, one of which having an upper surface positioned higher than that of the other in the axial direction, may be formed.

The sealing cap may include a first downward protrusion part formed at an inner edge thereof in the radial direction and protruded downwardly in the axial direction, and the first gap may be a gap between a lower end of the first downward protrusion part in the axial direction and the facing surface of the upper thrust member in the axial direction.

An upper surface of the hub may be provided with a second seating part stepped upwardly in the axial direction so that the sealing cap is seated on an inner side thereof in the radial direction and a gap part disposed outwardly of the second seating part in the radial direction, and an outer edge of the sealing cap in the radial direction may be provided with a second downward protrusion part, to be fitted into an outer surface of the second seating part in the radial direction.

An upper surface of the hub may be provided with the first seating part stepped downwardly in the axial direction so that the sealing cap is seated on the inner side thereof in the radial direction and the facing part disposed outwardly of the first seating part in the radial direction and be provided with a gap part formed outwardly of the facing part in the radial direction and stepped downwardly in the axial direction.

A sixth gap, an axial distance between an upper surface of the gap part in the axial direction and the line radially extended from the top of one of the shaft and the upper thrust member, one of which having an upper surface positioned higher than that of the other in the axial direction, may be larger than the first to third gaps.

A sixth gap, an axial distance between an upper surface of the gap part in the axial direction and the line radially extended from the top of one of the shaft and the upper thrust member, one of which having an upper surface positioned higher than that of the other in the axial direction, may be larger than the first to fourth gaps.

At least one of the facing surfaces of the sealing cap and the upper thrust member in the axial direction may have an oil repellent applied thereto.

An inner surface of the hub in the radial direction may be provided with a blocking groove or a blocking part stepped inwardly in the radial direction, and at least a portion between the blocking groove or the blocking part and an inner surface of the hub in the radial direction contacting the sealing cap may have an oil repellent applied thereto.

A portion at which the sealing cap and the hub are coupled to each other may be filled with an adhesive.

The sealing cap may be formed by performing plastic deformation on a steel sheet formed of a material including iron or stainless steel.

The facing surfaces of the upper thrust member and the sleeve or the hub in the axial direction may have a liquid-vapor interface formed therebetween.

The shaft and the upper thrust member may be formed integrally with each other.

The sleeve and the hub may be formed integrally with each other.

The second downward protrusion part and the outer surface of the second seating part in the radial direction may have an adhesive provided therebetween.

A portion at which the outer surface of the second seating part in the radial direction and the gap part meet each other may be provided with an adhesive collecting groove.

An outer surface of the upward protrusion part in the radial direction and a facing surface of the first seating part in the radial direction may be filled with an adhesive.

A portion at which surfaces of the first seating part in the radial direction and the axial direction meet each other may be provided with an adhesive collecting groove.

According to another aspect of the present invention, there is provided a hard disk drive including: the spindle motor as described above; a recording disk installed outwardly of the hub of the spindle motor in the radial direction; a ring shaped disk clamp provided on an outer surface of the hub in the radial direction and fixing the recording disk; and a top cover coupled to an upper end of one of the shaft and the upper thrust member, one of which having an upper surface positioned higher than that of the other in the axial direction.

The hard disk drive may have a thickness standard of 5 mm or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view showing a shape in which a top cover mounted on a spindle motor according to an embodiment of the present invention is warped;

FIGS. 2A and 2B are cross-sectional views of the spindle motor according to the embodiment of the present invention;

FIGS. 3A and 3B are cross-sectional views of a spindle motor according to another embodiment of the present invention;

FIGS. 4A and 4B are cross-sectional views of a spindle motor according to another embodiment of the present invention;

FIGS. 5A and 5B are cross-sectional views of a spindle motor according to another embodiment of the present invention;

FIGS. 6A and 6B are cross-sectional views of a spindle motor according to another embodiment of the present invention;

FIGS. 7A and 7B are cross-sectional views of a spindle motor according to another embodiment of the present invention; and

FIG. 8 is a schematic cross-sectional view of a disk driving device using the spindle motor according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

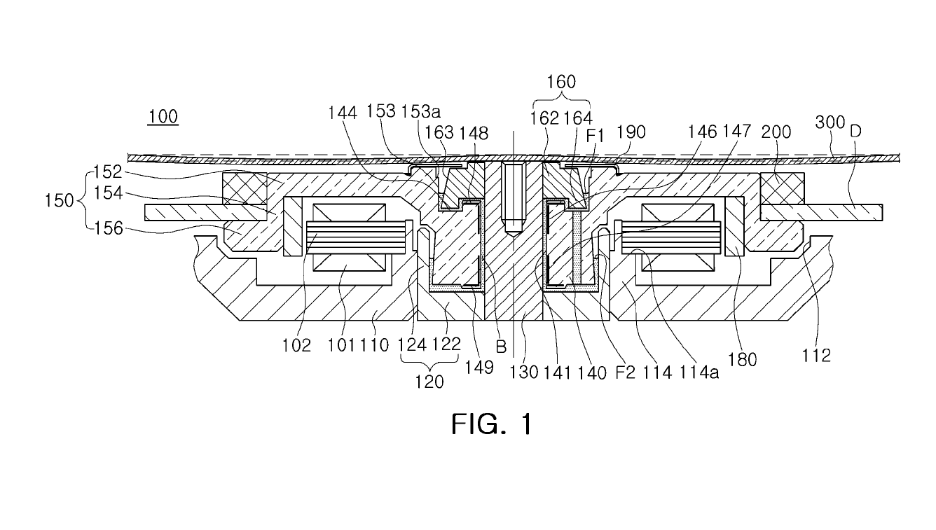

FIG. 1 is a cross-sectional view showing a shape before and after a top cover mounted on a spindle motor according to an embodiment of the present invention is warped.

Referring to FIG. 1, the spindle motor 100 according to the embodiment of the present invention may include a base member 110, a lower thrust member 120, a shaft 130, a sleeve 140, a hub 150, an upper thrust member 160, and a sealing cap 190.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, a radial direction refers to a horizontal direction, that is, a direction from the shaft 130 toward an outer peripheral surface of the hub 150 or from the outer peripheral surface of the hub 150 toward shaft 130, and a circumferential direction refers to a rotation direction along a predetermined radius at the center of rotation. For example, the circumferential direction refers to a rotation direction along the outer peripheral surface of the hub 150.

In the spindle motor 100 according to the embodiment of the present invention, a rotating member may relatively rotate smoothly with respect to a fixed member using a hydrodynamic bearing assembly.

Here, the hydrodynamic bearing assembly may be configured of members relatively rotating by fluid pressure generated in a lubricating fluid and includes the lower thrust member 120, the sleeve 140, the shaft 130, the upper thrust member 160, and the hub 150.

In addition, the rotating member, a member relatively rotating with respect to the fixed member, may include the sleeve 140, the hub 150, and a magnet 180 provided in the hub 150.

Further, the fixed member, a member fixed relative to the rotating member, may include the base member 110, the shaft 130, the lower thrust member 140, and the upper thrust member 160.

The base member 110 may include a mounting groove 112 so as to form a predetermined space with the hub 150. In addition, the base member 110 may include a coupling part 114 extended in an upward axial direction and having a stator core 102 installed on an outer peripheral surface thereof.

In addition, the coupling part 114 may include a seating surface 114a provided on the outer peripheral surface thereof so that the stator core 102 may be seated and installed thereon. Further, the stator core 102 seated on the coupling part 114 may be disposed over the mounting groove 112 of the base member 110 described above.

Meanwhile, the base member 110 according to the present embodiment may be manufactured by performing plastic working on a rolled steel sheet. More specifically, the base member 110 may be manufactured by a pressing method, a stamping method, a deep drawing method, or the like. However, the base member 110 is not limited to being manufactured by the above-mentioned method, but may be manufactured by various methods that are not exemplified, such as an aluminum die-casting method, and the like.

Meanwhile, since the base member 110 is manufactured by performing the plastic working on the rolled steel sheet, the base member 110 may have a thin and uniform thickness. Therefore, it is not easy to form the coupling part 114 included in the base member 110 integrally with the base member 110. Accordingly, in the case of the base member 110 according to the embodiment of the present invention, the coupling part 114 may be manufactured as a separate member and then coupled to the base member 110 at the time of assembling the spindle motor.

The lower thrust member 120 may be fixedly installed on the base member 110. That is, the lower thrust member 120 may be insertedly installed in the coupling part 114. More specifically, the lower thrust member 120 may be installed so that an outer peripheral surface thereof is bonded to an inner peripheral surface of the coupling part 114.

Meanwhile, the lower thrust member 120 may include a disk part 122 having an inner surface fixedly installed on the shaft 130 and an outer surface fixedly installed on the base member 110 and an extension part 124 extended from the disk part 122 in the upward axial direction.

That is, the lower thrust member 120 may have a cup shape with a hollow part. That is, the lower thrust member 120 may have a ‘ [symbol] ’ shaped cross section.

In addition, the disk part 122 may be provided with an installation hole 122a in which the shaft 130 is installed, and the shaft 130 may be insertedly mounted in the installation hole 122a.

Further, the lower thrust member 120 may be included, together with the base member 110, in a fixed member, that is, a stator.

Meanwhile, the outer surface of the lower thrust member 120 may be bonded to an inner surface of the base member 110 by an adhesive and/or welding. In other words, the outer surface of the lower thrust member 120 may be fixedly bonded to an inner surface of the coupling part 114 of the base member 110.

In addition, a lower thrust dynamic pressure groove 149 for generating thrust fluid dynamic pressure may be formed in at least one of an upper surface of the lower thrust member 120 and a lower surface 140b of the sleeve 140. Although the case in which the lower thrust dynamic pressure groove 149 is formed in the lower surface of the sleeve 140 has been shown in FIG. 1, the present invention is not limited thereto. That is, the lower thrust dynamic pressure groove 149 may be formed in the lower thrust member 120 facing the lower surface of the sleeve 140.

Further, the lower thrust member 120 may also serve as a sealing member for preventing the lubricating fluid from being leaked.

The shaft 130 may be fixedly installed on at least one of the lower thrust member 120 and the base member 110. That is, the shaft 130 may be installed so that a lower end portion thereof is inserted into the installation hole 122a formed in the disk part 122 of the lower thrust member 120.

In addition, the lower end portion of the shaft 130 may be bonded to an inner surface of the disk part 122 by an adhesive and/or welding. Therefore, the shaft 130 may be fixed.

However, although the case in which the shaft 130 is fixedly installed on the lower thrust member 120 has been described by way of example in the embodiment of the present invention, the present invention is not limited thereto. That is, the shaft 130 may also be fixedly installed on the base member 110. In the embodiment of the present invention, even in the case in which the shaft 130 is fixed to the base member 110 through the lower thrust member 120 or is fixed directly to the base member 110, it may be considered that the shaft 130 is installed on the base member 110.

Meanwhile, the shaft 130 may be also included, together with the lower thrust member 120 and the base member 110, in the fixed member, that is, the stator.

The shaft 130 may include a coupling unit, for example, a screw part 135 to which a screw is screwed, formed on an upper surface thereof so that a top cover 300 is fixedly installed thereto.

The sleeve 140 may be installed on be rotatable with respect to the shaft 130. To this end, the sleeve 140 may include a through-hole 141 into which the shaft 130 is inserted. Meanwhile, in the case in which the sleeve 140 is installed on the shaft 130, an inner peripheral surface of the sleeve 140 and an outer peripheral surface of the shaft 130 may be disposed to be spaced apart from each other by a predetermined gap to form a bearing clearance B therebetween. In addition, the bearing clearance B may be filled with the lubricating fluid.

Meanwhile, the sleeve 140 may include a step surface 144 formed in the upper end portion thereof in order to form a labyrinth shaped sealing part between the step surface 144 of the sleeve 140 and the upper thrust member 160. The lubricating fluid may be firmly sealed by the labyrinth shaped sealing part formed by the step surface 144 and the upper thrust member 160.

Meanwhile, the upper thrust member 160 may have an inclined part 163 formed at an outer surface of an upper end portion thereof so as to form a first liquid-vapor interface F1 between the upper thrust member 160 and the hub 150, wherein the inclined part 163 has an outer diameter larger at an upper portion thereof than at a lower portion thereof.

In other words, the inclined part 163 having the outer diameter larger at the upper portion thereof than at the lower portion thereof may be formed at the upper end portion of the upper thrust member 160 so that the first liquid-vapor interface F1 may be formed in a space between an outer peripheral surface of the upper thrust member 160 and an inner peripheral surface of the hub 150.

However, according to the embodiment of the present invention, the first liquid-vapor interface may also be formed between the upper thrust member 160 and the sleeve 140. The first liquid-vapor interface corresponds to apart represented by ‘F1’.

In addition, the sleeve 140 may have the hub 150 bonded to an outer peripheral surface thereof. That is, the sleeve 140 may include a bonding surface formed on the outer peripheral surface thereof.

Here, the sleeve 140 and the hub 150 may be formed integrally with each other. In the case in which the sleeve 140 and the hub 150 are formed integrally with each other, since both of the sleeve 140 and the hub 150 are provided as a single member, the number of components is decreased, whereby a product may be easily assembled and an assembly tolerance may be significantly decreased.

Meanwhile, a lower end portion of the outer peripheral surface of the sleeve 140 may be inclined upwardly inwardly in the radial direction so as to form a liquid-vapor interface together with the extension part 124 of the lower thrust member 120.

That is, the lower end portion of the sleeve 140 may be inclined upwardly inwardly in the radial direction so that a second liquid-vapor interface F2 may be formed in a space between the outer peripheral surface of the sleeve 140 and the extension part 124 of the lower thrust member 120. That is, a sealing part of the lubricating fluid may be formed in the space between the outer peripheral surface of the sleeve 140 and the extension part 124 of the lower thrust member 120.

As described above, since the second liquid-vapor interface F2 is formed in the space between the lower end portion of the sleeve 140 and the extension part 124, the lubricating fluid filled in the bearing clearance B may form the first liquid-vapor interfaces F1 and F1′ and the second liquid-vapor interface F2.

In addition, the sleeve 140 may include upper and lower radial dynamic pressure grooves 146 and 147 formed in an inner surface thereof in order to generate fluid dynamic pressure through the lubricating fluid filled in the bearing clearance B at the time of rotation thereof.

However, the upper and lower radial dynamic pressure grooves 146 and 147 are not limited to being formed in the inner surface of the sleeve 140 as shown in FIG. 1, but may also be formed in the outer peripheral surface of the shaft 130. In addition, the upper and lower radial dynamic pressure grooves 146 and 147 may have various shapes such as a herringbone shape, a spiral shape, a screw shape, and the like.

The hub 150 may be coupled to the sleeve 140 to rotate together with the sleeve 140.

The hub 150 may include a hub body 152 provided with an insertion part in which the upper thrust member 160 is insertedly disposed, a cylindrical wall part 154 extended from an edge of the hub body 152 and including a magnet 180 mounted on an inner surface thereof, and a disk mounting part 156 extended from an edge of the cylindrical wall part 154 outwardly in the radial direction.

Meanwhile, a lower end portion of an inner surface of the hub body 152 may be bonded to an outer surface of the sleeve 140. That is, the lower end portion of the inner surface of the hub body 152 may be bonded to the bonding surface of the sleeve 140 by an adhesive and/or welding.

Therefore, at the time of rotation of the hub 150, the sleeve 140 may rotate together with the hub 150.

In addition, the cylindrical wall part 154 may be extended from the hub body 152 downwardly in the axial direction. Further, the cylindrical wall part 154 may include the magnet 180 fixedly installed on the inner surface thereof.

An inner surface of the hub 150 in the radial direction, more specifically, an inner surface of the hub body 152 in the radial direction may be provided with a blocking groove (not shown) or a blocking part 153a stepped inwardly in the radial direction, and at least a portion between the blocking groove (not shown) or the blocking part 153a and the inner surface of the hub 150 in the radial direction contacting the sealing cap 190 may have an oil repellent applied thereto.

The magnet 180 may have an annular ring shape and be a permanent magnet generating a magnetic field having a predetermined strength by alternately magnetizing an N pole and an S pole in the circumferential direction.

Meanwhile, the magnet 180 may be disposed to face a front end of the stator core 102 having a coil 101 wound therearound and electromagnetically interact with the stator core 102 having the coil 101 wound therearound to generate driving force for rotating the hub 150.

Meanwhile, the upper thrust member 160 may be fixedly installed on an upper end portion of the shaft 130 and form the liquid-vapor interface together with the sleeve 140 or the hub 150.

Meanwhile, the upper thrust member 160 may include a body 162 having an inner surface bonded to the shaft 130 and a protrusion part 164 extended from the body 162 in the downwardly in the axial direction and forming the liquid-vapor interface together with an inclined part 153.

The protrusion part 164 may be extended from the body 162 in the downwardly in the axial direction and have an inner surface facing the outer surface of the sleeve 140 and an outer surface facing the inner surface of the hub 150.

In addition, although not shown, the protrusion part 164 may be extended from the body 162 so as to be parallel to the shaft 130.

In addition, the upper thrust member 160, which also is a fixed member fixedly installed together with the base member 110, the lower thrust member 120, and the shaft 130, may be a member configuring the stator.

Meanwhile, since the upper thrust member 160 is fixedly installed on the shaft 130 and the sleeve 140 rotates together with the hub 150, the first liquid-vapor interface F1 may be formed in a space between the hub 150 and the protrusion part 164. Therefore, the inner surface of the hub 150 may be provided with the inclined part 153.

The protrusion part 164 of the upper thrust member 160 may be disposed in a space formed by the sleeve 140 and the hub 150. In addition, the lubricating fluid may be filled in a labyrinth form in the spaces each formed by the sleeve 140 and a lower surface of the body 162 of the upper thrust member 160, the outer surface of the sleeve 140 and an inner surface of the protrusion part 164, and an outer surface of the protrusion part 164 and the inner surface of the hub 150, such that a sealing part is formed.

Therefore, the first liquid-vapor interface F1 may be formed in the space formed (F1′) by the outer surface of the sleeve 140 and the inner surface of the protrusion part 164 as well as the space formed by the outer surface of the upper thrust member 160 and the inner surface of the hub 150, as shown in FIG. 1. In the latter case, the outer surface of the sleeve 140 or the inner surface of the protrusion part 164 may be inclined to facilitate sealing of the lubricating fluid.

Meanwhile, an upper thrust dynamic pressure groove 148 for generating thrust dynamic pressure may be formed in at least one of a lower surface of the upper thrust member 160 and an upper surface of the sleeve 140 disposed to face the lower surface of the upper thrust member 160.

In addition, the upper thrust member 160 may also serve as a sealing member preventing the lubricating fluid filled in the bearing clearance B from being leaked upwardly.

Further, the upper thrust member 160 may be formed integrally with the shaft 130.

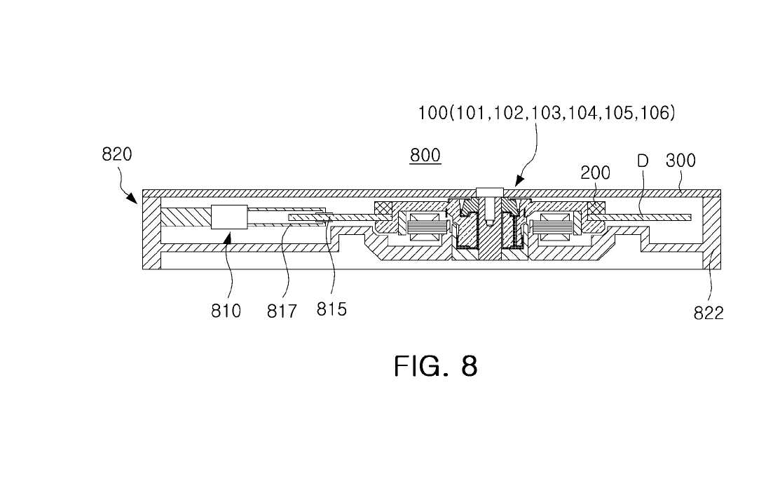

Further, in the case in which the spindle motor 100 is mounted in a hard disk drive 800 as shown in FIG. 8, the top cover 300 may be mounted on the upper end of the shaft 130. In this case, when external force is applied to the top cover 300, an amount of warpage of the top cover 300 based on the shaft 130 may be increased. Therefore, an upper surface of the upper thrust member 160 in the axial direction may be positioned in a position lower than that of the upper surface of the shaft 130 in the axial direction. However, the present invention is not limited thereto. That is, the upper surface of the upper thrust member 160 in the axial direction may be positioned in a position higher than that of the upper surface of the shaft 130 in the axial direction.

In addition, the spindle motor 100 according to the embodiment of the present invention may include the sealing cap 190 covering a space formed by the upper thrust member 160 and the hub 150 over the space.

The sealing cap 190 may be formed by performing plastic deformation on a steel sheet formed of a material including iron or stainless steel. More specifically, the sealing cap 190 may be manufactured by performing plastic working on a rolled steel sheet. The sealing cap 190 may be manufactured by a pressing method, a stamping method, a deep drawing method, or the like. However, the sealing cap 190 is not limited to being manufactured by the above-mentioned method, but may be manufactured by various methods that are not exemplified, such as an aluminum die-casting method, and the like.

Here, at least any one of facing surfaces of the sealing cap 190 and the upper thrust member 160 in the axial direction may have an oil repellent applied thereto.

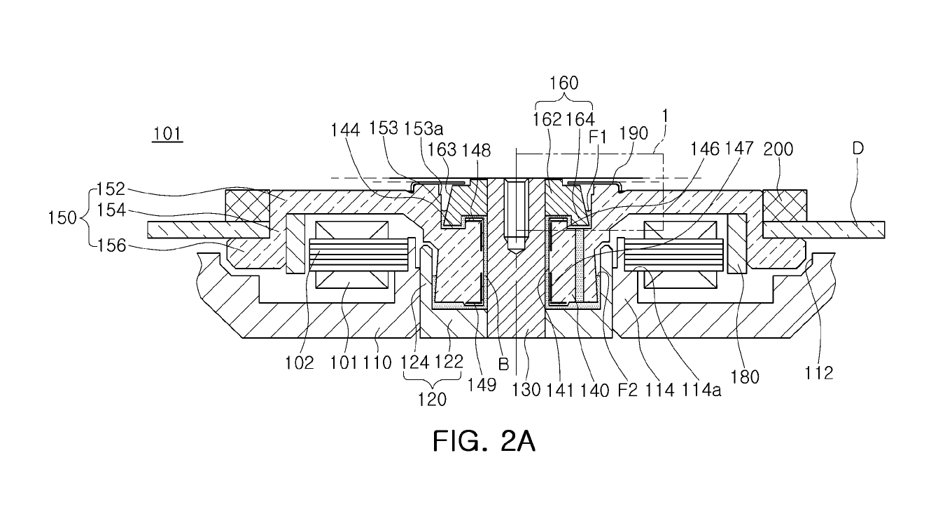

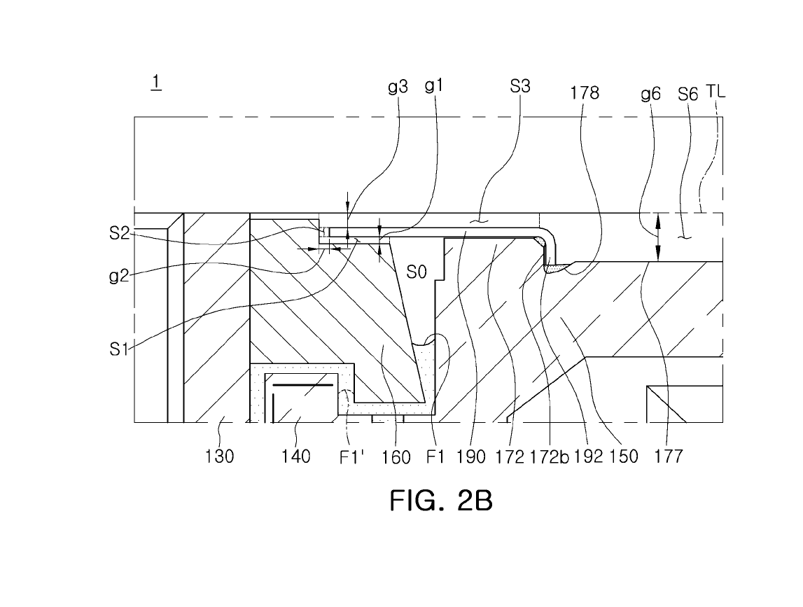

The sealing cap 190 may have a ring shape and have an outer edge fixed to the inner surface of the hub 150. That is, the sealing cap 190 may be fixed to an upper surface of an inner edge of the hub body 152 in the radial direction. In connection to this, various embodiments will be described in detail with reference to FIGS. 2A through 7B.

Meanwhile, recently, in accordance with thinning of a hard disk drive (HDD), a spindle motor mounted in the hard disk drive is also manufactured to have a thin thickness (a HDD standard of 5 mm or less). Therefore, in the thinned spindle motor, a length of the shaft is shortened, such that it is difficult to secure a span length between the upper and lower radial bearings.

According to the related art, a clamp is provided on an upper surface of a hub in an axial direction to occupy a space in the axial direction. However, in accordance with the thinness of the spindle motor, a method of allowing the clamp positioned on an upper surface of the hub in the axial direction to not occupy the space in the axial direction has been recently demanded in order to secure the span length of the radial bearing.

Therefore, the spindle motor according to the embodiment of the present invention may include a ring-shaped disk clamp 200 fitted into an outer surface of the rotating member, that is, the hub 150 in the radial direction to fix a recording disk D.

That is, in the embodiment of the present invention, the recording disk D may be disposed on an upper surface of the disk mounting part 156. Therefore, the disk clamp 200 may be fixed to an outer surface of the hub 150 in the radial direction, more specifically, an outer surface of the cylindrical wall part 154 in the radial simultaneously with pressing the recording disk D at an upper portion of the recording disk D in the axial direction.

Here, the disk clamp 200 may be coupled to the outer surface of the hub by various methods such as a screwing method, a press-fitting method, a clip coupling method, and the like. However, the present invention is not limited thereto. That is, various structural components may be used as long as they may be coupled to the outer surface of the hub 150 in the radial direction to fix the recording disk D.

Meanwhile, in the case of a thin fixed shaft type spindle motor 100 according to the embodiment of the present invention, the top cover 300 may be fixedly mounted on the upper end of the shaft 130. The top cover 300 may be provided along apart of which an upper surface in the axial direction is higher in the shaft 130 and the upper thrust member 160 disposed outwardly of the shaft 130 in the radial direction.

In this case, a distance between facing surfaces of the top cover 300 and the hub 150 in the axial direction may become closer as compared with the motor according to the related art. However, as shown in FIG. 1, the top cover 300 may be warped by external force (in FIG. 1, the top cover 300 before being warped is represented by a dotted line and the top cover 300 after being warped is represented by a solid line). Therefore, a contact between the top cover and the hub due to the external force may be prevented.

In this case, a gap between the top cover 300 and the hub 150 may be determined in consideration of a material of the top cover 300, a threshold value of applied external power, and a design margin according thereto.

Hereinafter, a structure of the sealing cap 190 according to the embodiment of the present invention and a structure in which the sealing cap 190 is mounted in the spindle motor 100, or 101, 102, 103, 104, 105, or 106 will be described with reference to FIGS. 2A through 7B. Further, in the case in which the spindle motor 100 is mounted in the hard disk drive 800 as shown in FIG. 8, it includes the top cover 300. Therefore, a sealing effect according to the top cover will be additionally described.

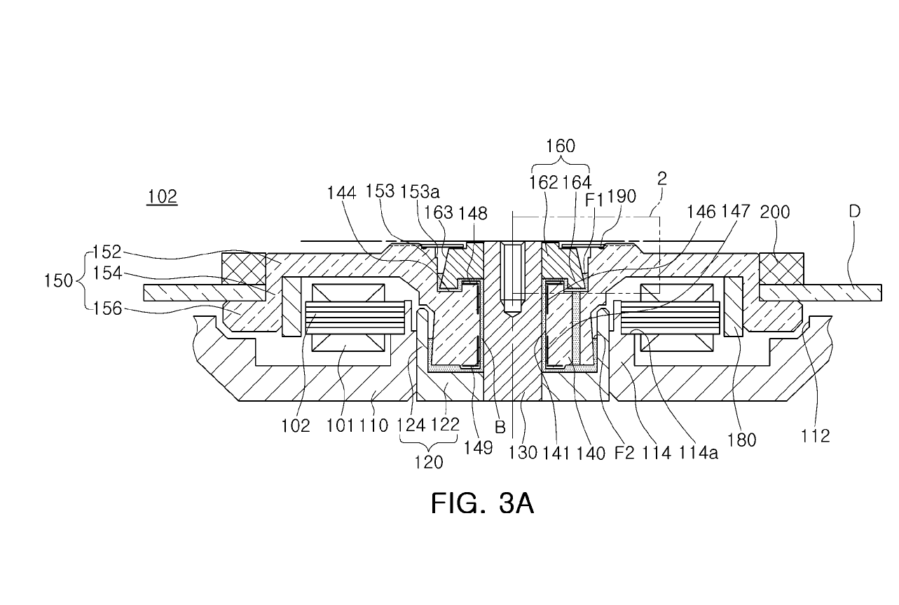

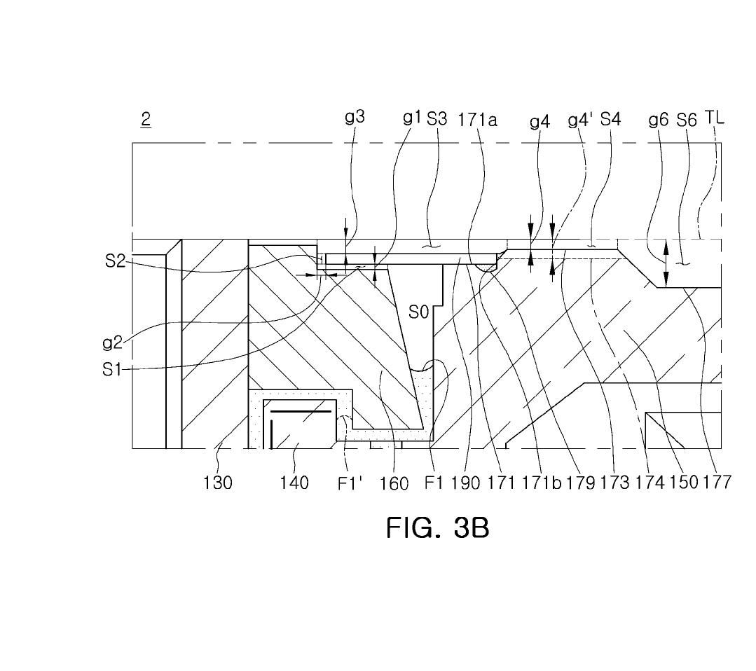

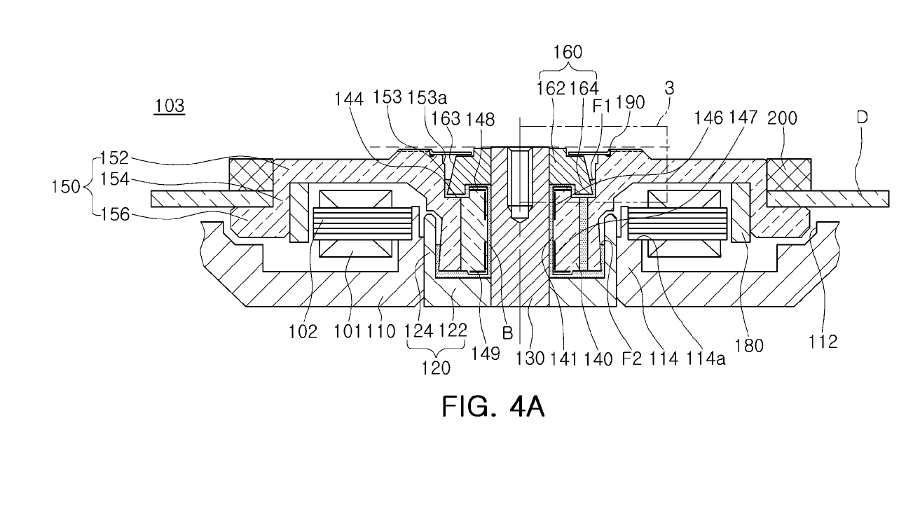

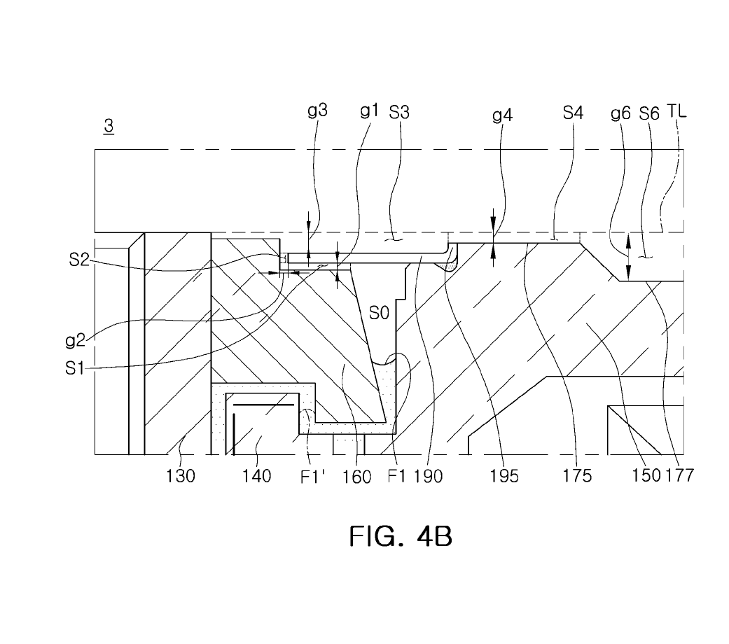

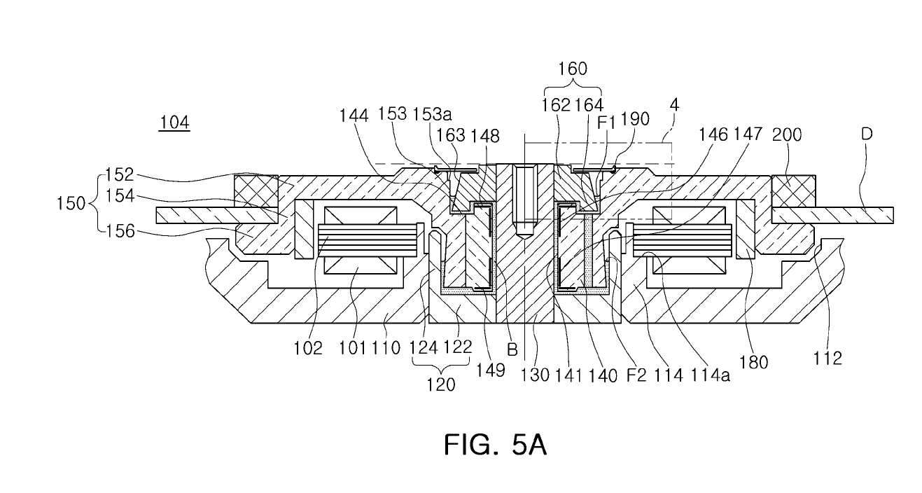

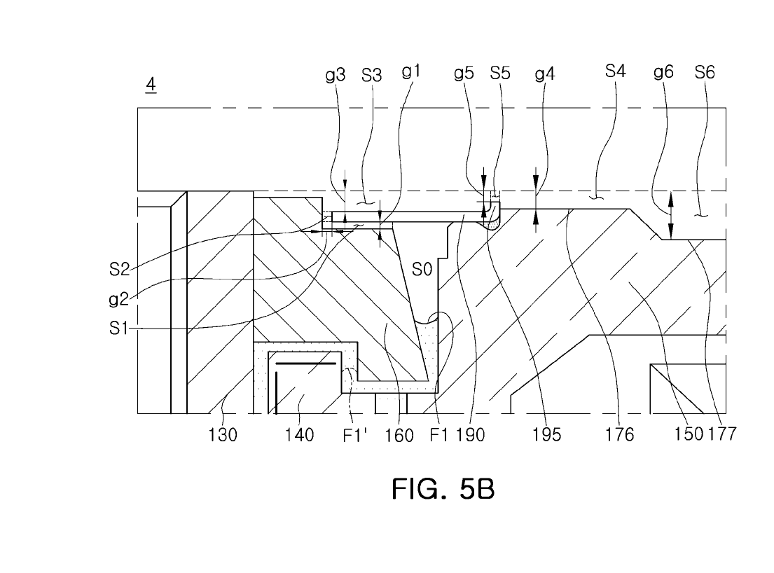

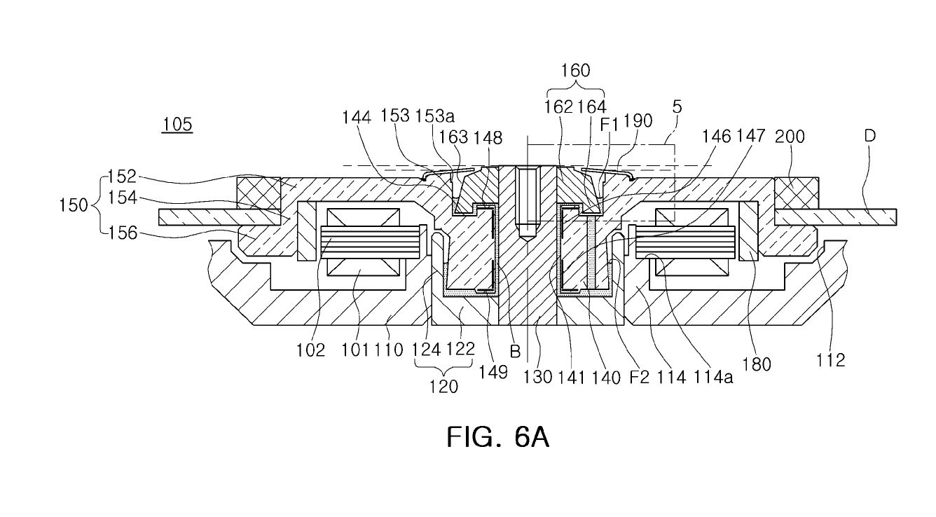

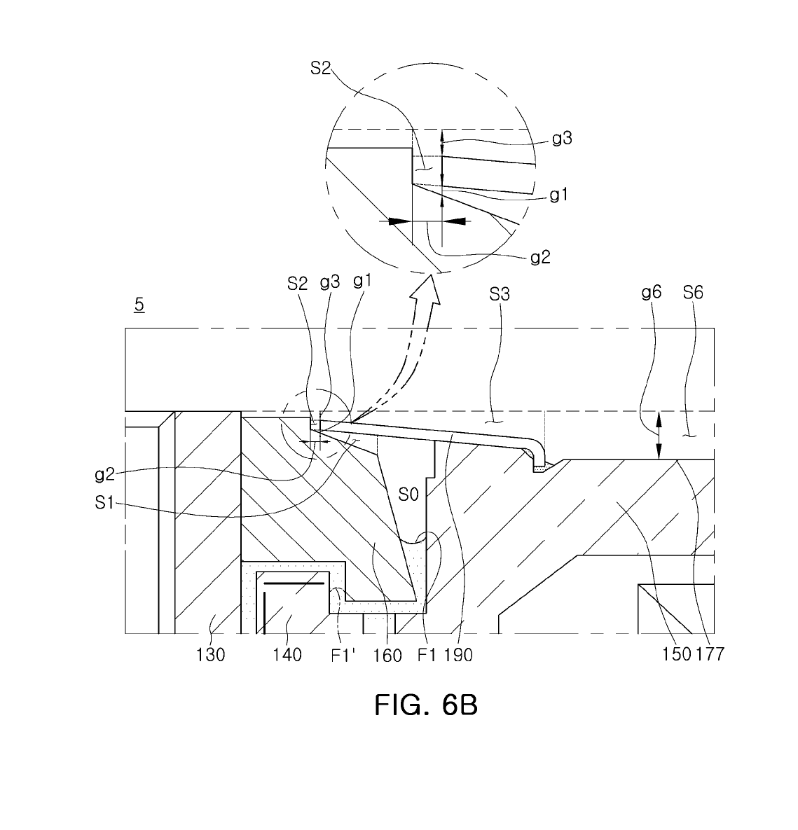

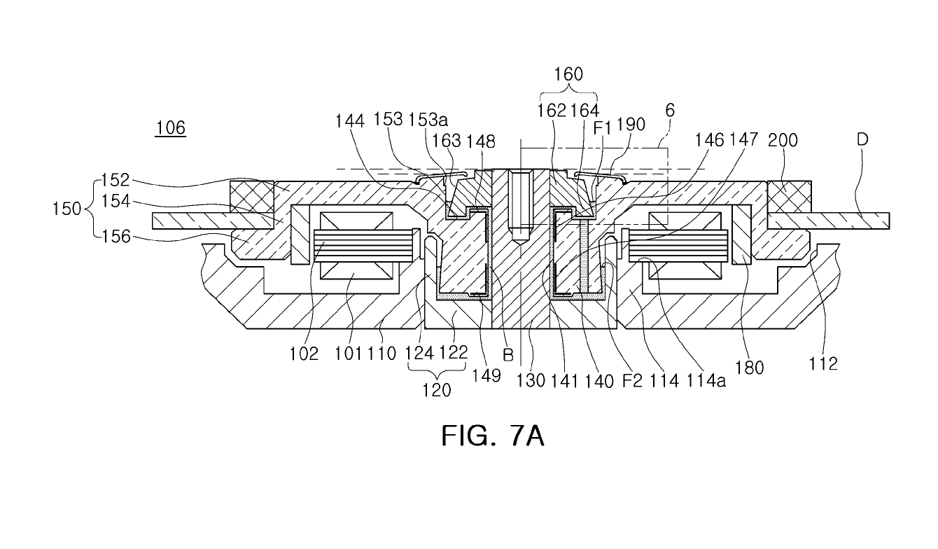

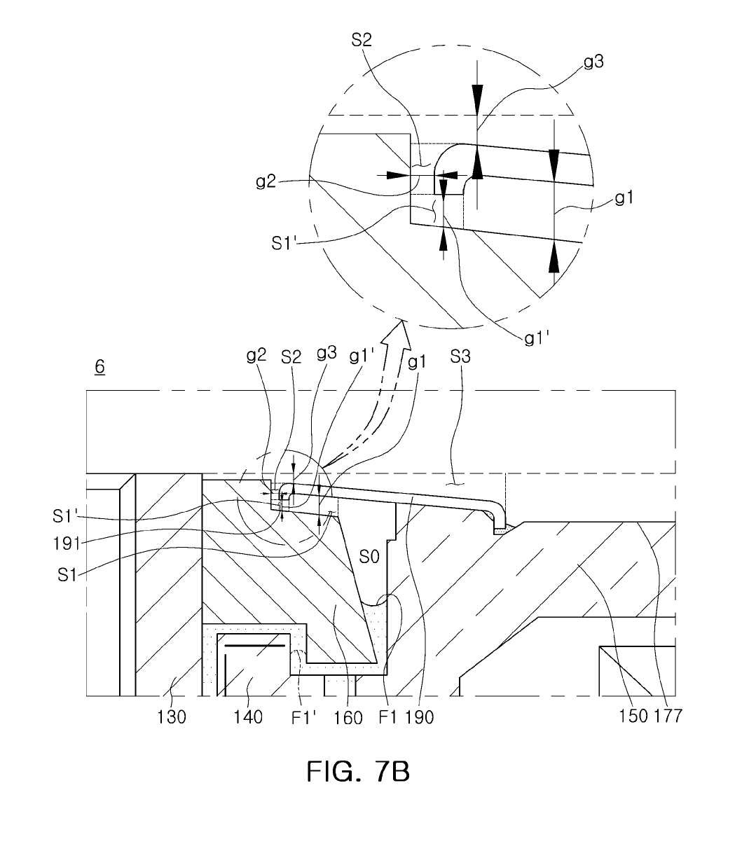

FIGS. 2A and 2B are cross-sectional views of the spindle motor according to the embodiment of the present invention; FIGS. 3A and 3B are cross-sectional views of a spindle motor according to another embodiment of the present invention; FIGS. 4A and 4B are cross-sectional views of a spindle motor according to another embodiment of the present invention; FIGS. 5A and 5B are cross-sectional views of a spindle motor according to another embodiment of the present invention; FIGS. 6A and 6B are cross-sectional views of a spindle motor according to another embodiment of the present invention; and FIGS. 7A and 7B are cross-sectional views of a spindle motor according to another embodiment of the present invention.

Referring to FIGS. 2A and 2B, in the spindle motor 101 according to the embodiment of the present invention, the sealing cap 190 may be mounted on the hub 150 and be extended to an upper portion of the upper thrust member 160 in the axial direction so as to cover a space S0 formed in the axial direction between the upper thrust member 160 and the hub 150. FIG. 2B is an enlarged view of a part ‘1’ of FIG. 2A.

Therefore, an upper surface of the hub 150 may be provided with a second seating part 172 stepped in the upward axial direction so that the sealing cap 190 is seated on an inner side thereof in the radial direction and a gap part 177 disposed outwardly of the second seating part 172 in the radial direction.

Therefore, an outer edge of the sealing cap 190 in the radial direction may be fixed to an upper surface of the second seating part 172.

Further, the sealing cap 190 may include a second downward protrusion part 192 formed at an outer edge thereof in the radial direction to thereby be fitted into an outer surface 172b of the second seating part 172 in the radial direction.

Here, the sealing cap 190 may be coupled to the second sealing part 172 by various methods such as a press-fitting coupling method, a sliding coupling method, a welding coupling method, an adhesive bonding method, and the like.

Therefore, a portion at which the sealing cap 190 and the hub 150 are coupled to each other may be filled with an adhesive. More specifically, the second downward protrusion part 192 and the outer surface of the second seating part 172 in the radial direction may have the adhesive provided therebetween. Further, a portion at which the outer surface of the second seating part 172 in the radial direction and the gap part 177 meet each other may be provided with an adhesive collecting groove 178.

Meanwhile, in the spindle motor 101 according to the embodiment of the present invention, a zeroth space S0 (means a space from the first liquid-vapor interface F1′ in a direction in which air moves in the case in which the first liquid-vapor interface F1′ is formed between the upper trust member 160 and the sleeve 140) may be formed between the upper thrust member 160 and the hub 150 between which the first liquid-vapor interface F1 is formed.

In addition, the sealing cap 190 may form several spaces between the sealing cap 190 and members adjacent thereto. More specifically, a first space S1 may be between facing surfaces of the upper thrust member 160 and the sealing cap 190 in the axial direction, a second space S2 may be formed between facing surfaces of the sealing cap 190 and the shaft 130 or the upper thrust member 160 in the radial direction, and a third space S3 may be formed between an upper surface of the sealing cap 190 in the axial direction and a top line TL radially extended from a top of one of the shaft 130 and the upper thrust member 160, one of which having an upper surface positioned to be higher than that of the other. In addition, a sixth space S6 may be formed between the gap part 177 and the top line TL.

Therefore, the spaces from the first liquid-vapor interface F1 or F1′ to the outside, that is, in the direction in which the air moves may be formed in a sequence of the zeroth space S0, the first space S1, the second space S2, the third space S3, and the sixth space S6.

In the spindle motor 101 according to the embodiment of the present invention, scattering or leakage of a fluid may be generated along the zeroth space S0, the first space S1, the second space S2, the third space S3, and the sixth space S6. Therefore, in the embodiment of the present invention, a labyrinth seal may be formed in the zeroth space S0, the first space S1, the second space S2, and the third space S3.

Therefore, all of a first gap g1 between the facing surfaces of the upper thrust member 160 and the sealing cap 190 in the axial direction, a second gap g2 between the facing surfaces of the sealing cap 190 and the shaft 130 or the upper thrust member 160 in the radial direction, and a third gap g3 between the upper surface of the sealing cap 190 in the axial direction and the top line TL may be narrow enough to form the labyrinth seal. That is, all of the first gap g1, the second gap g2, and the third gap g3 may be 0.5 mm or less.

Further, relative sizes of the first gap g1, the second gap g2, and the third gap g3 may be sequentially alternated. That is, both of the first and third gaps g1 and g3 may be larger than the second gap g2 or be smaller than the second gap g2.

In the case in which the spaces from the first liquid-vapor interface F1 or F1′ to the outside, that is, in the direction in which the air moves, has the above-mentioned shape, a sealing effect of the labyrinth seal may be significantly increased. In the case in which the spaces through which the fluid is leaked or scattered are formed as the labyrinth seal and the relative sizes of the gaps from the first liquid-vapor interface F1 or F1′ to the outside, that is, in the direction in which the air moves are changed, since air pressure is continuously changed in the respective spaces S0 to S3, a flow of the air may be more efficiently blocked. Since the leaked or scattered lubricating fluid is in a state that is substantially similar to a gas state, when the spaces are formed as described above so that a pressure difference may be continuously generated, the leakage or the scattering of the lubricating fluid may be may be significantly decreased.

Meanwhile, a sixth gap g6 may be formed in a space between facing surfaces of the gap part 177 and the top line TL in the axial direction. The sixth gap g6 may be sufficiently large that the top cover 300 does not contact the gap part 177 even in the case in which it is provided on the top line TL and is warped due to the external force. Therefore, the sixth gap g6 may be larger than those of the first to third gaps g1 to g3.

Next, referring to FIGS. 3A and 3B, in the spindle motor 102 according to another embodiment of the present invention, the sealing cap 190 may be mounted on the hub 150 and be extended to an upper portion of the upper thrust member 160 in the axial direction so as to cover a space S0 formed in the axial direction between the upper thrust member 160 and the hub 150. FIG. 3B is an enlarged view of a part ‘2’ of FIG. 3A.

Therefore, an upper surface of the hub 150 may be provided with a first seating part 171 stepped downwardly in the axial direction so that the sealing cap 190 is seated on an inner side thereof in the radial direction and a facing part 173 or 174 disposed outwardly of the first seating part 171 in the radial direction. Here, the facing part 173 or 174 may be divided into a first facing part 173 in the case in which it is provided in a position higher than that of the upper surface of the sealing cap 190 in the axial direction and a second facing part 174 in the case in which it is provided in a position lower than that of the upper surface of the sealing cap 190 in the axial direction. Meanwhile, the upper surface of the hub 150 may be provided with a gap part 177 formed outwardly of the facing part 173 or 174 in the radial direction and stepped downwardly.

Therefore, an outer edge of the sealing cap 190 in the radial direction may be fixed to an upper surface of the first seating part 171.

Further, the outer edge of the sealing cap 190 in the radial direction may be fitted into an outer surface 171b of the first seating part 171 in the radial direction.

Here, the sealing cap 190 may be coupled to the first sealing part 171 by various methods such as a press-fitting coupling method, a sliding coupling method, a welding coupling method, an adhesive bonding method, and the like.

Therefore, a portion at which the sealing cap 190 and the hub 150 are coupled to each other may be filled with the adhesive. More specifically, a radial surface of an outer edge portion of the sealing cap 190 in the radial direction and a radial surface of the outer surface 171b facing the radial surface of the outer edge portion of the sealing cap 190 may have the adhesive provided therebetween and an axial surface of the outer edge portion of the sealing cap 190 in the radial direction and an axial surface of the first seating part 171 facing the axial surface of the outer edge portion of the sealing cap 190 may also have the adhesive provided therebetween. Further, a portion at which a lower surface 171a of the first seating part 171 in the axial direction and the outer surface 171b thereof in the radial direction meet each other may be provided with an adhesive collecting groove 179.

Meanwhile, in the spindle motor 102 according to another embodiment of the present invention, a zeroth space S0 (means a space from the first liquid-vapor interface F1′ in a direction in which air moves in the case in which the first liquid-vapor interface F1′ is formed between the upper trust member 160 and the sleeve 140) may be formed between the upper thrust member 160 and the hub 150 between which the first liquid-vapor interface F1 is formed.

In addition, the sealing cap 190 may form several spaces between the sealing cap 190 and members adjacent thereto. More specifically, a first space S1 may be formed between facing surfaces of the upper thrust member 160 and the sealing cap 190 in the axial direction, a second space S2 may be formed between facing surfaces of the sealing cap 190 and the shaft 130 or the upper thrust member 160 in the radial direction, a third space S3 may be formed between an upper surface of the sealing cap 190 in the axial direction and a top line TL radially extended from a top of one of the shaft 130 and the upper thrust member 160, one of which having an upper surface positioned to be higher than that of the other, and a fourth space S4 or S4′ may be formed between the top line TL and the facing part 173 or 174. In addition, a sixth space S6 may be formed between the gap part 177 and the top line TL.

Therefore, the spaces from the first liquid-vapor interface F1 or F1′ to the outside, that is, in the direction in which the air moves may be formed in a sequence of the zeroth space S0, the first space S1, the second space S2, the third space S3, the fourth space S4, and the sixth space S6.

In the spindle motor 102 according to the embodiment of the present invention, scattering or leakage of a fluid may be generated along the zeroth space S0, the first space S1, the second space S2, the third space S3, the fourth space S4, and the sixth space S6. Therefore, in the embodiment of the present invention, a labyrinth seal may be formed in the zeroth space S0, the first space S1, the second space S2, the third space S3, and the fourth space S4.

Therefore, all of a first gap g1 between the facing surfaces of the upper thrust member 160 and the sealing cap 190 in the axial direction, a second gap g2 between the facing surfaces of the sealing cap 190 and the shaft 130 or the upper thrust member 160 in the radial direction, a third gap g3 between the upper surface of the sealing cap 190 in the axial direction and the top line TL, and a fourth gap g4 between the upper surface of the facing part 173 or 174 of the top line TL in the axial direction may be narrow enough to form the labyrinth seal. That is, all of the first gap g1, the second gap g2, the third gap g3, and the fourth gap g4 may be 0.5 mm or less.

Further, relative sizes of the first gap g1, the second gap g2, the third gap g3, and the fourth gap g4 may be sequentially alternated. That is, both of the first and third gaps g1 and g3 may be larger than the second gap g2 and the third gap g3 may be larger than the fourth gap g4 or both of the first and third gaps g1 and g3 may be smaller than the second gap g2 and the third gap g3 may be smaller than the fourth gap g4. The former case may correspond to the case in which the facing part is provided as the first facing part 173, and the latter case may correspond to the case in which the facing part is provided as the second facing part 174.

In the case in which the spaces from the first liquid-vapor interface F1 or F1′ to the outside, that is, in the direction in which the air moves, has the above-mentioned shape, a sealing effect of the labyrinth seal may be significantly increased. In the case in which the spaces through which the fluid is leaked or scattered are formed as the labyrinth seal and the relative sizes of the gaps from the first liquid-vapor interface F1 or F1′ to the outside, that is, in the direction in which the air moves are changed, since air pressure is continuously changed in the respective spaces S0 to S4, a flow of the air may be more efficiently blocked. Since the leaked or scattered lubricating fluid is in a state that is substantially similar to a gas state, when the spaces are formed as described above so that a pressure difference may be continuously generated, the leakage or the scattering of the lubricating fluid may be may be significantly decreased efficiently.

Meanwhile, a sixth gap g6 may be formed in a space between facing surfaces of the gap part 177 and the top line TL in the axial direction. The sixth gap g6 may be sufficiently large that the top cover 300 does not contact the gap part 177 even in the case in which it is provided on the top line TL and is warped due to the external force Therefore, the sixth gap g6 may be larger than those of the first to fourth gaps g1 to g4.

Next, referring to FIGS. 4A and 4B, in the spindle motor 103 according to another embodiment of the present invention, the sealing cap 190 may be mounted on the hub 150 and be extended to an upper portion of the upper thrust member 160 in the axial direction so as to cover a space S0 formed in the axial direction between the upper thrust member 160 and the hub 150. The spindle motor 103 according to the present embodiment is different from the spindle motor 102 described with reference to FIGS. 3A and 3B in that the sealing cap 190 includes an upward protrusion part 195 formed at an outer edge thereof in the radial direction and protruded upwardly in the axial direction. The upward protrusion part 195 may be formed by upwardly bending the outer edge of the sealing cap 190 in the radial direction. FIG. 4B is an enlarged view of part ‘3’ of FIG. 4A.

Since other components are the same as those of the spindle motor 102 described with reference to FIGS. 3A and 3B, only components different from those of the spindle motor 102 described with reference to FIGS. 3A and 3B will be described.

An upper surface of the hub 150 may be provided with a first seating part 171 stepped downwardly in the axial direction so that the sealing cap 190 is seated on an inner side thereof in the radial direction and a facing part 175 disposed outwardly of the first seating part 171 in the radial direction. Here, an upper surface of the facing part 175 in the axial direction may be positioned in a position higher than or equal to that of an upper surface of the upward protrusion part 195 of the sealing cap 190 in the axial direction. Meanwhile, the upper surface of the hub 150 may be provided with a gap part 177 formed outwardly of the facing part 175 in the radial direction and stepped downwardly.

Meanwhile, since the spindle motor 103 according to the present embodiment is substantially the same as the spindle motor 102 described with reference to FIGS. 3A and 3B except that the facing part 175 is positioned in a position higher than that of the upper surface of the sealing cap 190 in the axial direction, see the case in which the spindle motor 102 described with reference to FIGS. 3A and 3B includes the first facing part 173 with respect to a mechanism associated with the efficient sealing of the lubricating fluid.

Next, referring to FIGS. 5A and 5B, in the spindle motor 104 according to another embodiment of the present invention, the sealing cap 190 may be mounted on the hub 150 and extended to an upper portion of the upper thrust member 160 in the axial direction so as to cover a space S0 formed in the axial direction between the upper thrust member 160 and the hub 150. The spindle motor 104 according to the present embodiment is different from the spindle motor 102 described with reference to FIGS. 3A and 3B in that the sealing cap 190 includes an upward protrusion part 195 formed at an outer edge thereof in the radial direction and protruded upwardly in the axial direction. The upward protrusion part 195 may be formed by upwardly bending the outer edge of the sealing cap 190 in the radial direction. FIG. 5B is an enlarged view of part ‘4’ of FIG. 5A.

Since other components are the same as those of the spindle motor 102 described with reference to FIGS. 3A and 3B, only components different from those of the spindle motor 102 described with reference to FIGS. 3A and 3B will be described.

An upper surface of the hub 150 may be provided with a first seating part 171 stepped in downwardly in the axial direction so that the sealing cap 190 is seated on an inner side thereof in the radial direction and a facing part 176 disposed outwardly of the first seating part 171 in the radial direction. Here, an upper surface of the facing part 176 in the axial direction may be positioned in a position lower than that of an upper surface of the upward protrusion part 195 of the sealing cap 190 in the axial direction. Meanwhile, the upper surface of the hub 150 may be provided with a gap part 177 formed outwardly of the facing part 176 in the radial direction and stepped downwardly.

Meanwhile, in the spindle motor 104 according to the present embodiment, since the facing part 176 is positioned in the position lower than that of the upper surface of the upward protrusion part 195 in the axial direction, the spindle motor 104 according to the present embodiment may further include a portion at which pressure of air is changed (a portion ‘S5’ to be described below) as compared with the spindle motor 102 described with reference to FIGS. 3A and 3B.

In the spindle motor 104 according to another embodiment of the present invention, a zeroth space S0 (means a space from the first liquid-vapor interface F1′ in a direction in which air moves in the case in which the first liquid-vapor interface F1′ is formed between the upper trust member 160 and the sleeve 140) may be formed between the upper thrust member 160 and the hub 150 between which the first liquid-vapor interface F1 is formed.

In addition, the sealing cap 190 may form several spaces between the sealing cap 190 and members adjacent thereto. More specifically, a first space S1 may be formed between facing surfaces of the upper thrust member 160 and the sealing cap 190 in the axial direction, a second space S2 may be formed between facing surfaces of the sealing cap 190 and the shaft 130 or the upper thrust member 160 in the radial direction, a third space S3 may be formed between an upper surface of the sealing cap 190 in the axial direction and a top line TL radially extended from a top of one of the shaft 130 and the upper thrust member 160 of which one of which having an upper surface positioned to be higher than that of the other, a fourth space S4 may be formed between the top line TL and the facing part 175, and a fifth space S5 may be formed between the top line TL and the upward protrusion part 195. In addition, a sixth space S6 may be formed between the gap part 177 and the top line TL.

Therefore, the spaces from the first liquid-vapor interface F1 or F1′ to the outside, that is, in the direction in which the air moves may be formed in a sequence of the zeroth space S0, the first space S1, the second space S2, the third space S3, the fifth space S5, the fourth space S4, and the sixth space S6.

In the spindle motor 104 according to the embodiment of the present invention, scattering or leakage of a fluid may be generated along the zeroth space S0, the first space S1, the second space S2, the third space S3, the fifth space S5, the fourth space S4, and the sixth space S6. Therefore, in the embodiment of the present invention, a labyrinth seal may be formed in the zeroth space S0, the first space S1, the second space S2, the third space S3, the fifth space S5, and the fourth space S4.

Therefore, all of a first gap g1 between the facing surfaces of the upper thrust member 160 and the sealing cap 190 in the axial direction, a second gap g2 between the facing surfaces of the sealing cap 190 and the shaft 130 or the upper thrust member 160 in the radial direction, a third gap g3 between the upper surface of the sealing cap 190 in the axial direction and the top line TL, a fifth gap g5 between the upper surface of the upward protrusion part 195 in the axial direction and the top line TL, and a fourth gap g4 between the upper surface of the facing part 176 and the top line TL in the axial direction may be narrow enough to form the labyrinth seal. That is, all of the first gap g1, the second gap g2, the third gap g3, the fifth gap g5, and the fourth gap g4 may be 0.5 mm or less.

Further, relative sizes of the first gap g1, the second gap g2, the third gap g3, the fifth gap g5, and the fourth gap g4 may be sequentially alternated. That is, both of the first and third gaps g1 and g3 may be larger than the second gap g2 and both of the third and fourth gaps g3 and g4 may be larger than the fifth gap g5.

In the case in which the spaces from the first liquid-vapor interface F1 or F1′ to the outside, that is, in the direction in which the air moves, has the above-mentioned shape, a sealing effect of the labyrinth seal may be significantly increased. In the case in which the spaces through which the fluid is leaked or scattered are formed as the labyrinth seal and the relative sizes of the gaps from the first liquid-vapor interface F1 or F1′ to the outside, that is, in the direction in which the air moves are changed, since air pressure is continuously changed in the respective spaces S0 to S4, a flow of the air may be more efficiently blocked. Since the leaked or scattered lubricating fluid is in a state that is substantially similar to a gas state, when the spaces are formed as described above so that a pressure difference may be continuously generated, the leakage or the scattering of the lubricating fluid may be may be significantly decreased efficiently.

Meanwhile, a sixth gap g6 may be formed in a space between facing surfaces of the gap part 177 and the top line TL in the axial direction. The sixth gap g6 may be sufficiently large that the top cover 300 does not contact the gap part 177 even in the case in which it is provided on the top line TL and is warped due to the external force Therefore, the sixth gap g6 may be larger than those of the first gap g1, the second gap g2, the third gap g3, the fifth gap g5, and the fourth gap g4.

Next, referring to FIGS. 6A and 6B, in the spindle motor 105 according to another embodiment of the present invention, the sealing cap 190 may be mounted on the hub 150 and be extended to an upper portion of the upper thrust member 160 in the axial direction so as to cover a space S0 formed in the axial direction between the upper thrust member 160 and the hub 150. The spindle motor 105 according to the present embodiment is different from the spindle motor 102 described with reference to FIGS. 3A and 3B in that the sealing cap 190 is inclined upwardly inwardly in the radial direction. FIG. 6B is an enlarged view of part ‘5’ of FIG. 6A.

Since other components are the same as those of the spindle motor 102 described with reference to FIGS. 3A and 3B, only components different from those of the spindle motor 102 described with reference to FIGS. 3A and 3B will be described.

In the spindle motor 105 according to the present embodiment, the sealing cap 190 may be inclined upwardly from the outer portion thereof toward the inner portion thereof in the radial direction, such that gaps in the axial direction or the radial direction may be changed in the respective spaces S1 to S3.

Therefore, the first gap g1, the second gap g2, and the third gap g3 may be portions at which gaps are the smallest in corresponding spaces S1 to S3, respectively.

Since the spindle motor 105 according to the present embodiment is substantially the same as the spindle motor 102 described with reference to FIGS. 3A and 3B except that the first gap g1, the second gap g2, and the third gap g3 are the portions at which the gaps are the smallest in corresponding spaces S1 to S3, respectively, see the case the spindle motor 102 described with reference to FIGS. 3A and 3B with respect to a mechanism associated with the efficient sealing of the lubricating fluid.

Next, referring to FIGS. 7A and 7B, in the spindle motor 106 according to another embodiment of the present invention, the sealing cap 190 may be mounted on the hub 150 and be extended to an upper portion of the upper thrust member 160 in the axial direction so as to cover a space S0 formed in the axial direction between the upper thrust member 160 and the hub 150. The spindle motor 106 according to the present embodiment is different from the spindle motor 105 described with reference to FIGS. 6A and 6B in that the sealing cap 190 includes a first downward protrusion part 191 formed at an inner edge thereof in the radial direction and protruded downwardly in the axial direction. FIG. 7B is an enlarged view of part ‘6’ of FIG. 7A.

Since other components are the same as those of the spindle motor 105 described with reference to FIGS. 6A and 6B, only components different from those of the spindle motor 105 described with reference to FIGS. 6A and 6B will be described.

In the spindle motor 106 according to the present embodiment, since the sealing cap 190 includes a first downward bent part 191 at the inner portion thereof in the radial direction, another portion at which the pressure of the air is changed from the first liquid-vapor interface F1 or F1′ in the direction in which the air moves may be added.

The spindle motor 106 according to the present embodiment may further include a first additional space S1′ formed between facing surfaces of the upper thrust member 160 and the first downward protrusion part 191 in the axial direction.

A first additional gap g1′ corresponding to a portion at which a gap in the axial direction is the smallest may be formed in the first additional space S1′.

Therefore, in order to form an efficient labyrinth seal, the first additional gap g1′ may be smaller than the first and second gaps g1 and g2. That is, regardless of relative sizes of the first and second gaps g1 and g2, the first additional gap g1′ may be smaller than the first and second gaps g1 and g2.

FIG. 8 is a schematic cross-sectional view of a disk driving device using the spindle motor according to the embodiment of the present invention.

Referring to FIG. 8, a recording disk driving device 800 having the spindle motor 100, 101, 102, 103, 104, 105, or 106 according to the embodiment of the present invention mounted therein may be a hard disk drive and include the spindle motor 100, 101, 102, 103, 104, 105, or 106, a head transfer part 810, and a housing 820. A thickness standard of the recording disk driving device 800 may be 5 mm or less.

The spindle motor 100, 101, 102, 103, 104, 105, or 106 may have all the characteristics of the spindle motor according to the embodiments of the present invention described above and may have a recording disk D mounted thereon. The recording disk D may be fixed by the disk clamp 200.

The head transfer part 810 may transfer a magnetic head 815 detecting information of the recording disk 830 mounted on the spindle motor 100, 101, 102, 103, 104, 105, or 106 to a surface of the recording disk of which the information is to be detected.

Here, the magnetic head 815 may be disposed on a support part 817 of the head transfer part 810.

The housing 820 may include a motor mounting plate 822 and a top cover 300 shielding an upper portion of the motor mounting plate 822 in order to form an internal space receiving the spindle motor 100, 101, 102, 103, 104, 105, or 106 and the head transfer part 810 therein.

The head transfer part 810 may be formed of a voice coil motor (VCM).

As set forth above, with the spindle motor according to the embodiment of the present invention, the clamp fixing the recording disk may not occupy a space in the axial direction.

In addition, with the spindle motor according to the embodiment of the present invention, even in the case in which a thin fixed shaft type spindle motor is used, a contact between the top cover and the hub may not be generated.

Further, with the spindle motor according to the embodiment of the present invention, as the gap between the top cover and the hub is narrowed, the gap between the top cover and the hub may used to improve performance of the motor.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a shaft fixedly installed on a base member and including an upper thrust member provided in an upper portion thereof and protruded outwardly in a radial direction;
a sleeve supported by fluid dynamic pressure so as to be rotatable with respect to the shaft;
a hub extended from the sleeve outwardly in the radial direction; and
a sealing cap mounted on the hub and extended to an upper portion of the upper thrust member so as to cover a space between the upper thrust member and the hub formed in the axial direction,
wherein the upper thrust member and the sleeve or the hub include a liquid-vapor interface formed therebetween,
a first gap between facing surfaces of the upper thrust member and the sealing cap in the axial direction, a second gap between facing surfaces of the sealing cap and the shaft or the upper thrust member in the radial direction, and a third gap, an axial distance between an upper surface of the sealing cap in the axial direction and a line radially extended from a top of one of the shaft and the upper thrust member, one of which having an upper surface positioned to be higher than that of the other in the axial direction, are narrow enough to form a labyrinth seal, and
the first to third gaps have sequentially alternated relative sizes.

2. The spindle motor of claim 1, wherein the first and third gaps are larger than the second gap.

3. The spindle motor of claim 1, wherein an upper surface of the hub is provided with a first seating part stepped downwardly in the axial direction so that the sealing cap is seated on an inner side thereof in the radial direction and a facing part disposed outwardly of the first seating part in the radial direction, and
a fourth gap, an axial distance between the facing part and the line radially extended from the top of one of the shaft and the upper thrust member, one of which having an upper surface positioned to be higher than that of the other in the axial direction is narrow enough to form the labyrinth seal.

4. The spindle motor of claim 3, wherein the first to fourth gaps have sequentially alternated relative sizes.

5. The spindle motor of claim 4, wherein the facing part is a first facing part positioned in a position higher than the upper surface of the sealing cap in the axial direction, and
the first and third gaps are larger than the second gap and the fourth gap is smaller than the third gap.

6. The spindle motor of claim 4, wherein the facing part is a second facing part positioned in a position lower than the upper surface of the sealing cap in the axial direction, and
the first and third gaps are smaller that the second gap and the fourth gap is larger than the third gap.

7. The spindle motor of claim 1, wherein the sealing cap is inclined upwardly from an outer portion thereof toward an inner portion thereof in the radial direction.

8. The spindle motor of claim 3, wherein the sealing cap is inclined upwardly from an outer portion thereof toward an inner portion thereof in the radial direction.

9. The spindle motor of claim 3, wherein the sealing cap includes an upward protrusion part formed at an outer edge thereof in the radial direction and protruded upwardly in the axial direction, and
a fifth gap, an axial distance between the upward protrusion part and the line radially extended from the top of one of the shaft and the upper thrust member, one of which having an upper surface positioned higher than that of the other in the axial direction, is formed.

10. The spindle motor of claim 1, wherein the sealing cap includes a first downward protrusion part formed at an inner edge thereof in the radial direction and protruded downwardly in the axial direction, and
the first gap is a gap between a lower end of the first downward protrusion part in the axial direction and the facing surface of the upper thrust member in the axial direction.

11. The spindle motor of claim 1, wherein an upper surface of the hub is provided with a second seating part stepped upwardly in the axial direction so that the sealing cap is seated on an inner side thereof in the radial direction and a gap part disposed outwardly of the second seating part in the radial direction, and
an outer edge of the sealing cap in the radial direction is provided with a second downward protrusion part, to be fitted into an outer surface of the second seating part in the radial direction.

12. The spindle motor of claim 3, wherein the upper surface of the hub is provided with the first seating part stepped downwardly in the axial direction so that the sealing cap is seated on the inner side thereof in the radial direction and the facing part disposed outwardly of the first seating part in the radial direction and is provided with a gap part formed outwardly of the facing part in the radial direction and stepped downwardly in the axial direction.

13. The spindle motor of claim 11, wherein a sixth gap, an axial distance between an upper surface of the gap part in the axial direction and the line radially extended from the top of one of the shaft and the upper thrust member, one of which having an upper surface positioned higher than that of the other in the axial direction, is larger than the first to third gaps.

14. The spindle motor of claim 12, wherein a sixth gap, an axial distance between an upper surface of the gap part in the axial direction and the line radially extended from the top of one of the shaft and the upper thrust member, one of which having an upper surface positioned higher than that of the other in the axial direction, is larger than the first to fourth gaps.

15. The spindle motor of claim 1, wherein at least one of the facing surfaces of the sealing cap and the upper thrust member in the axial direction has an oil repellent applied thereto.

16. The spindle motor of claim 1, wherein an inner surface of the hub in the radial direction is provided with a blocking groove or a blocking part stepped inwardly in the radial direction, and
at least a portion between the blocking groove or the blocking part and an inner surface of the hub in the radial direction contacting the sealing cap has an oil repellent applied thereto.

17. The spindle motor of claim 1, wherein a portion at which the sealing cap and the hub are coupled to each other is filled with an adhesive.

18. The spindle motor of claim 1, wherein the sealing cap is formed by performing plastic deformation on a steel sheet formed of a material including iron or stainless steel.

19. The spindle motor of claim 1, wherein the facing surfaces of the upper thrust member and the sleeve or the hub in the axial direction have a liquid-vapor interface formed therebetween.

20. The spindle motor of claim 1, wherein the shaft and the upper thrust member are formed integrally with each other.

21. The spindle motor of claim 1, wherein the sleeve and the hub are formed integrally with each other.

22. The spindle motor of claim 11, wherein the second downward protrusion part and the outer surface of the second seating part in the radial direction have an adhesive provided therebetween.

23. The spindle motor of claim 22, wherein a portion at which the outer surface of the second seating part in the radial direction and the gap part meet each other is provided with an adhesive collecting groove.

24. The spindle motor of claim 9, wherein an outer surface of the upward protrusion part in the radial direction and a facing surface of the first seating part in the radial direction are filled with an adhesive.

25. The spindle motor of claim 24, wherein a portion at which surfaces of the first seating part in the radial direction and the axial direction meet each other is provided with an adhesive collecting groove.

26. A hard disk drive comprising:
the spindle motor of claim 1;
a recording disk installed outwardly of the hub of the spindle motor in the radial direction;
a ring shaped disk clamp provided on an outer surface of the hub in the radial direction and fixing the recording disk; and
a top cover coupled to an upper end of one of the shaft and the upper thrust member, one of which having an upper surface positioned higher than that of the other in the axial direction.

27. The hard disk drive of claim 26, wherein the hard disk drive has a thickness standard of 5 mm or less.
